(19) United States
(12) Patent Application Publication
(10) Pub. No.: US 2020/0310315 A1
(43) Pub. Date: Oct. 1, 2020

(54) IMAGE FORMING APPARATUS

(71) Applicant: CANON KABUSHIKI KAISHA, Tokyo (JP)

(72) Inventor: Michihito Yamazaki, Tokyo (JP)

(21) Appl. No.: 16/830,034

(22) Filed: Mar. 25, 2020

(30) Foreign Application Priority Data
Mar. 29, 2019 (JP) 2019-068891

(51) Int. Cl. G03G 15/00; B65H 7/14

(52) U.S. Cl. CPC G03G 15/5029; G03G 15/6561; G03G 15/6508; G03G 15/5016; G03G 15/5062; B65H 7/14; B65H 2553/41; G03G 2215/00751; G03G 2215/00383; G03G 2215/00409; G03G 2215/00637; G03G 2215/00616; B65H 2553/30; G03G 2215/00738

(57) ABSTRACT

An image forming apparatus includes an image forming unit to form an image on a sheet conveyed from a sheet storing unit by a sheet conveying unit, and a registering unit that registers detected sheet thickness information and detected sheet surface characteristics information. Based on information, distinct front and back surfaces of a conveyed predetermined sheet and a type of the conveyed predetermined sheet is determined. If the predetermined sheet type matches a type of an upcoming sheet on which the image will be formed and the determined front and back surfaces matches front and back surfaces of the upcoming sheet, an image is formed on the predetermined sheet. If the predetermined sheet type matches the upcoming sheet type and the determined front and back surfaces do not match the upcoming sheet front and back surfaces, information is displayed conveying that the predetermined sheet front and back surfaces are inverted.

### BACKGROUND

### Field

The present disclosure relates to an image forming apparatus.

### Description of the Related Art

A technique is known for determining the thickness of a sheet on the basis of the intensity of transmitted waves and the intensity of reflection waves at the time of irradiation of the sheet with ultrasonic waves and controlling image forming conditions according to the determined thickness of the sheet (see Japanese Patent Laid-Open No. 2004-107030).

A technique is also known for determining the surface characteristics of a sheet on the basis of transmitted light and reflected light at the time of irradiation of the sheet with light and controlling image forming conditions according to the determined surface characteristics of the sheet (see Japanese Patent Laid-Open No. 2007-233186).

Label paper tends to have a significantly different reflection pattern when the label paper is irradiated with ultrasonic waves or light. Accordingly, in a case where a sheet has a significantly different reflection pattern when the sheet is irradiated with ultrasonic waves or light, it can be determined that the sheet is label paper.

In recent years, special label paper (a sheet having a unique label pattern; for example, a medical wristband label) rather than existing label paper has been used. A reflection pattern at the time of irradiation of the special label paper with ultrasonic waves or light is different from a reflection pattern at the time of irradiation of the existing label paper with ultrasonic waves or light.

In the special label paper, one surface (a front surface) is a print surface, and the other surface (a back surface) is a non-print surface. Therefore, in the formation of an image on the special label paper, if a sheet is stored in a sheet storing unit included in an image forming apparatus in a state where front and back surfaces of the sheet are incorrectly disposed, there is a possibility that a desired printed matter will not be obtained. Accordingly, in the formation of an image on the special label paper, when the special label paper is stored in the sheet storing unit, it is requested that the front and back surfaces of the special label paper be correctly set.

In addition, the special label paper has a distinction between a leading end and a rear end on a print surface. Therefore, in the formation of an image on the special label paper, if a sheet is stored in a sheet storing unit included in an image forming apparatus in a state where the leading and rear ends of the sheet are incorrectly disposed, there is a possibility that a desired printed matter will not be obtained. Accordingly, in the formation of an image on the special label paper, when the special label paper is stored in the sheet storing unit, it is requested that the leading and rear ends of the special label paper be correctly set.

### SUMMARY

A new mechanism is requested that is capable of determining a type and front and back surfaces of a predetermined sheet having a distinction between the front and back surfaces (for example, special label paper or the like) on the basis of a reflection pattern at the time of irradiation of the predetermined sheet with ultrasonic waves or light.

Further, a new mechanism is requested that is capable of determining a type and leading and rear ends of a predetermined sheet having a distinction between the leading and rear ends (for example, special label paper or the like) on the basis of a reflection pattern at the time of irradiation of the predetermined sheet with ultrasonic waves or light.

The image forming apparatus in the present disclosure works towards determining a type and leading and rear ends of a predetermined sheet having a distinction between the leading and rear ends.

According to an aspect of the present disclosure, an image forming apparatus for forming an image on a sheet, includes a sheet storing unit configured to store the sheet, a sheet conveying unit configured to convey the sheet stored in the sheet storing unit, an image forming unit configured to form the image on the sheet conveyed by the sheet conveying unit, a first detecting sensor configured to detect information regarding a thickness of the sheet conveyed by the sheet conveying unit, wherein the first detecting sensor is disposed on a downstream side of the sheet storing unit and on an upstream side of the image forming unit with respect to a sheet conveyance direction of the sheet conveying unit, a second detecting sensor configured to detect information regarding a surface characteristics of the sheet conveyed by the sheet conveying unit, wherein the second detecting sensor is disposed on the downstream side of the sheet storing unit and on the upstream side of the image forming unit with respect to the sheet conveyance direction of the sheet conveying unit, a registering unit configured to register the information regarding the thickness of the sheet detected by the first detecting sensor and the information regarding the surface characteristics of the sheet detected by the second detecting sensor, a display unit, and a controller configured to perform control, wherein, in a case where a predetermined sheet having a distinction between front and back surfaces has been conveyed by the sheet conveying unit, the controller performs control to: determine, based on information regarding at least one sheet, the front and back surfaces of the predetermined sheet and a type of the predetermined sheet conveyed by the sheet conveying unit, wherein the information regarding the at least one sheet includes (i) information regarding a thickness of the predetermined sheet detected by the first detecting sensor, (ii) information regarding a surface characteristics of the predetermined sheet detected by the second detecting sensor, (iii) the registered information regarding the thickness of the sheet, and (iv) the registered information regarding the surface characteristics of the sheet, control the image forming unit to permit formation of the image on the predetermined sheet, in a case where the determined type of the predetermined sheet matches a type of a sheet on which the image will be formed by the image forming unit and the determined front and back surfaces of the predetermined sheet matches front and back surfaces of the sheet on which the image will be formed by the image forming unit, and control to display, on the display unit, information indicating that the front and back surfaces of the predetermined sheet stored in the sheet storing unit are inverted, in a case where the determined type of the predetermined sheet matches the type of the sheet on which the image will be formed by the image forming unit and the determined front and back surfaces of the predetermined sheet do not match the front and back surfaces of the sheet on which the image will be formed by the image forming unit.

In an example, a controller performs, in the case of conveyance of a predetermined sheet having a distinction between leading and rear ends, determining a type and leading and rear ends of the predetermined sheet based on detected information regarding a thickness and surface characteristics of the predetermined sheet and registered information regarding a thickness and surface characteristics, controlling image formation to be permitted on the predetermined sheet, in a case where the determined type and leading and rear ends of the predetermined sheet match a type and leading and rear ends of a sheet for image formation, and controlling information to be displayed, in a case where the determined type matches the type of the sheet and the determined leading and rear ends do not match the leading and rear ends of the sheet, the information indicating inversion of the leading and rear ends of the stored predetermined sheet.

Further features of the present disclosure will become apparent from the following description of exemplary embodiments (with reference to the attached drawings).

### BRIEF DESCRIPTION OF THE DRAWINGS

FIG. 1 is a sectional view illustrating a configuration of an image forming apparatus.

FIG. 2 is a schematic diagram for explaining a configuration of a medium sensor relating to the detection of surface characteristics of a recording medium.

FIG. 3 is a schematic diagram for explaining a configuration of a medium sensor relating to the detection of a density and a basis weight of a recording medium.

FIG. 4 is a diagram illustrating an example of a print surface of a medical wristband label.

FIGS. 5A and 5B are diagrams illustrating a waveform obtained by detecting surface characteristics on a side of the print surface of the medical wristband label.

FIG. 6 is a diagram illustrating a waveform obtained by detecting surface characteristics on a side of a non-print surface of the medical wristband label.

FIGS. 7A and 7B are flowcharts for explaining an example of control according to a first embodiment.

FIG. 8 is a diagram for explaining a configuration of a screen according to the first embodiment.

FIG. 9 is a diagram for explaining a configuration of a screen according to the first embodiment.

FIG. 10 is a diagram for explaining a configuration of a screen according to the first embodiment.

FIG. 11 is a diagram for explaining a configuration of a screen according to the first embodiment.

FIG. 12 is a diagram for explaining a configuration of a screen according to the first embodiment.

FIG. 13 is a diagram for explaining a configuration of a screen according to the first embodiment.

FIG. 14 is a diagram for explaining a configuration of a screen according to the first embodiment.

FIG. 15 is a diagram for explaining a configuration of a screen according to the first embodiment.

FIG. 16 is a diagram for explaining a configuration of a screen according to the first embodiment.

FIG. 17 is a flowchart for explaining an example of control according to the first embodiment.

FIG. 18 is a diagram illustrating a waveform obtained by detecting surface characteristics on a side of a front surface of emboss α.

FIG. 19 is a diagram illustrating a waveform obtained by detecting surface characteristics on a side of a back surface of emboss α.

FIG. 20 is a flowchart for explaining an example of control according to a second embodiment.

### DESCRIPTION OF THE EMBODIMENTS

Embodiments of the present disclosure are described in detail below with reference to the drawings. The embodiments described below do not limit the present disclosure described in the claims. The present disclosure can be embodied for various purposes such as printers, various printing machines, copying machines, facsimile machines, or multifunction devices.

### First Embodiment

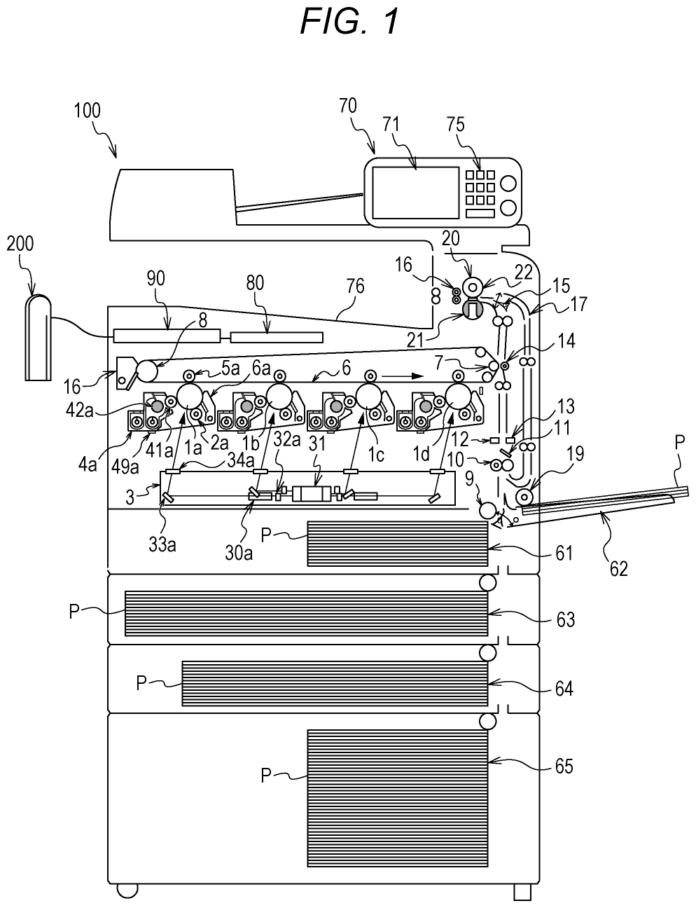

A first embodiment of the present disclosure is described with reference to FIGS. 1 to 17.

FIG. 1 is a sectional view illustrating a principal configuration of a multifunction printer (MFP) that is an image forming apparatus 100 according to the first embodiment.

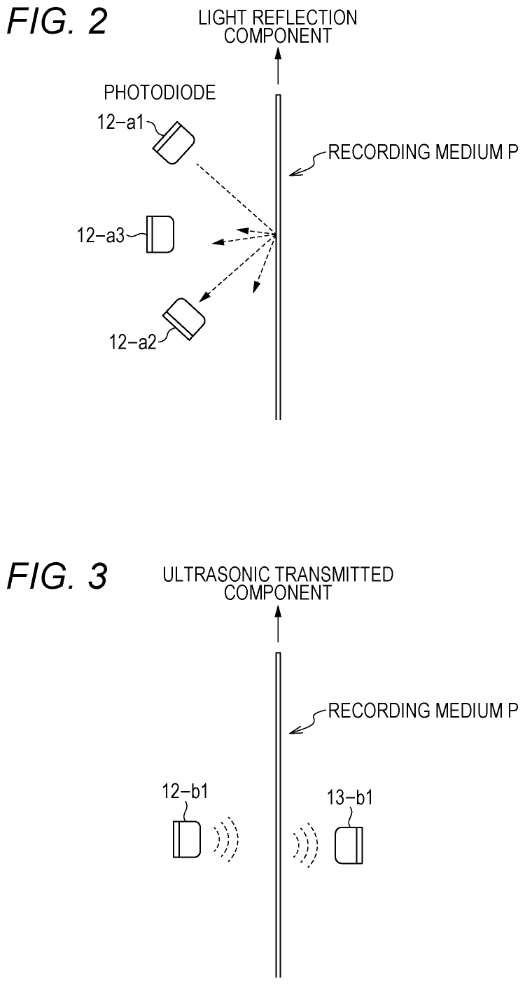

FIG. 2 is a diagram illustrating a disposition relationship between a conveyance path of a recording medium P and a reference light irradiation photodiode 12-a1, a specular reflection light detection photodiode 12-a2, and a diffuse reflection light detection photodiode 12-a3 that are light-emitting units in medium sensors 12 and 13.

FIG. 3 is a diagram illustrating a disposition relationship between the conveyance path of the recording medium P and an ultrasonic transmitter 12-b1 and an ultrasonic receiver 13-b1 in the medium sensors 12 and 13.

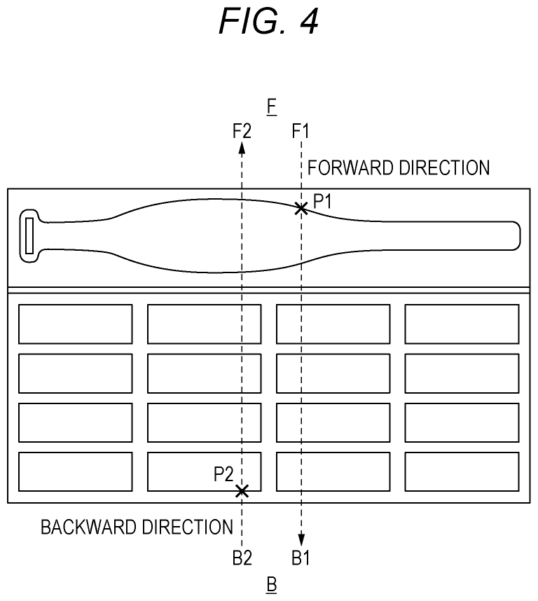

FIG. 4 is a diagram illustrating a print surface of a “medical wristband label” serving as the recording medium P. In the first embodiment, the “medical wristband label” is an example of special label paper (a sheet having a unique label pattern). A size of the “medical wristband label” is a letter size having a longitudinal width of 279 mm and a lateral width of 216 mm.

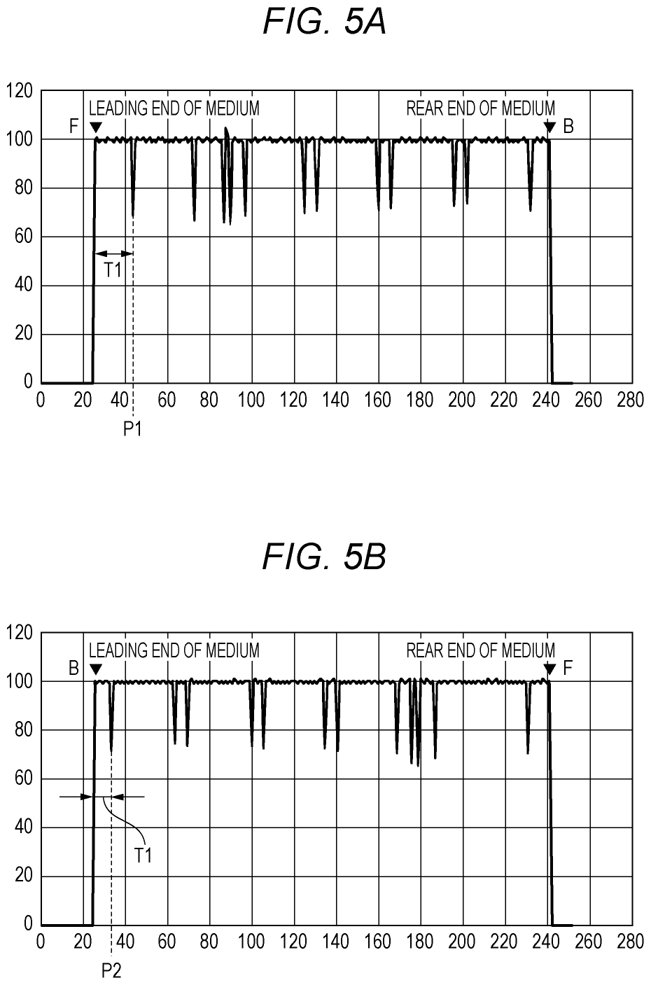

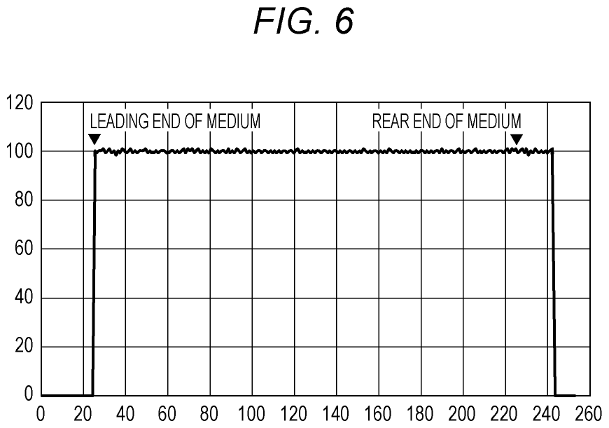

FIG. 5A is a diagram illustrating an amount of diffuse reflection light on a front surface of the “medical wristband label” that is detected by the diffuse reflection light detection photodiode 12-a3 at the time of conveyance in a forward direction of the “medical wristband label.” A horizontal axis indicates a value in terms of a length in a conveyance direction, and the amount of diffuse reflection light has been standardized under the assumption that an average intensity during sheet supply is 100.

FIG. 5B is a diagram illustrating a profile of an amount of diffuse reflection light on the front surface of the “medical wristband label” that is detected by the diffuse reflection light detection photodiode 12-a3 at the time of conveyance in a backward direction of the “medical wristband label,” in a manner similar to the manner of FIG. 5A.

FIG. 6 is a diagram illustrating a profile of an amount of diffuse reflection light on a back surface of the “medical wristband label” that is detected by the diffuse reflection light detection photodiode 12-a3 at the time of conveyance of the “medical wristband label” with front and back surfaces inverted, in a manner similar to the manners of FIGS. 5A and 5B.

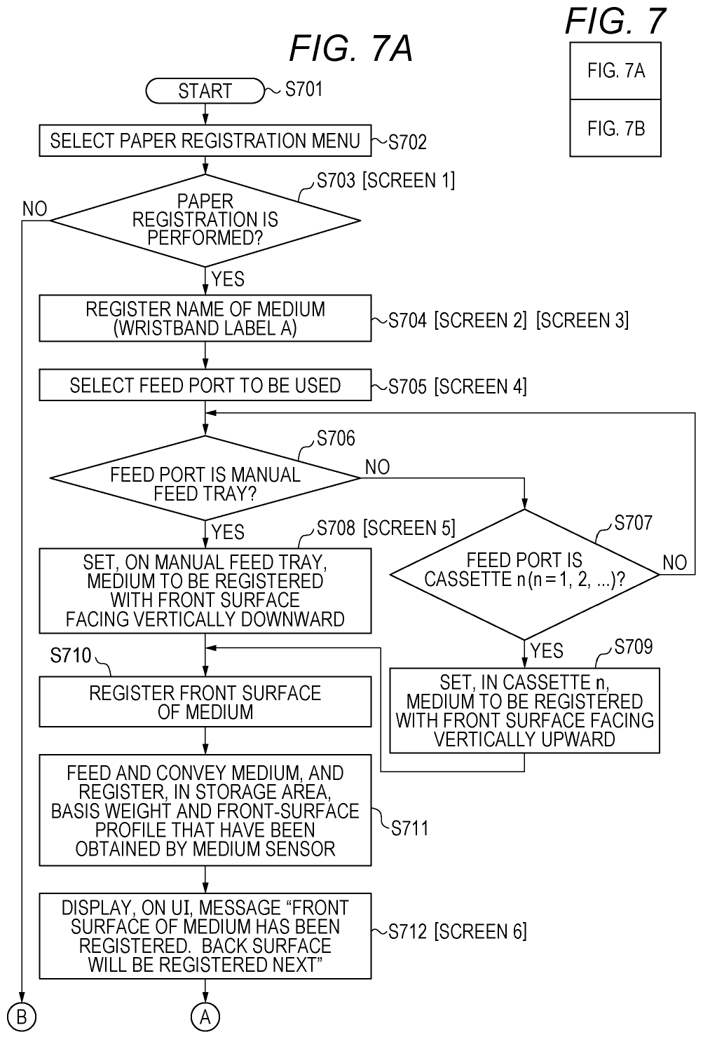

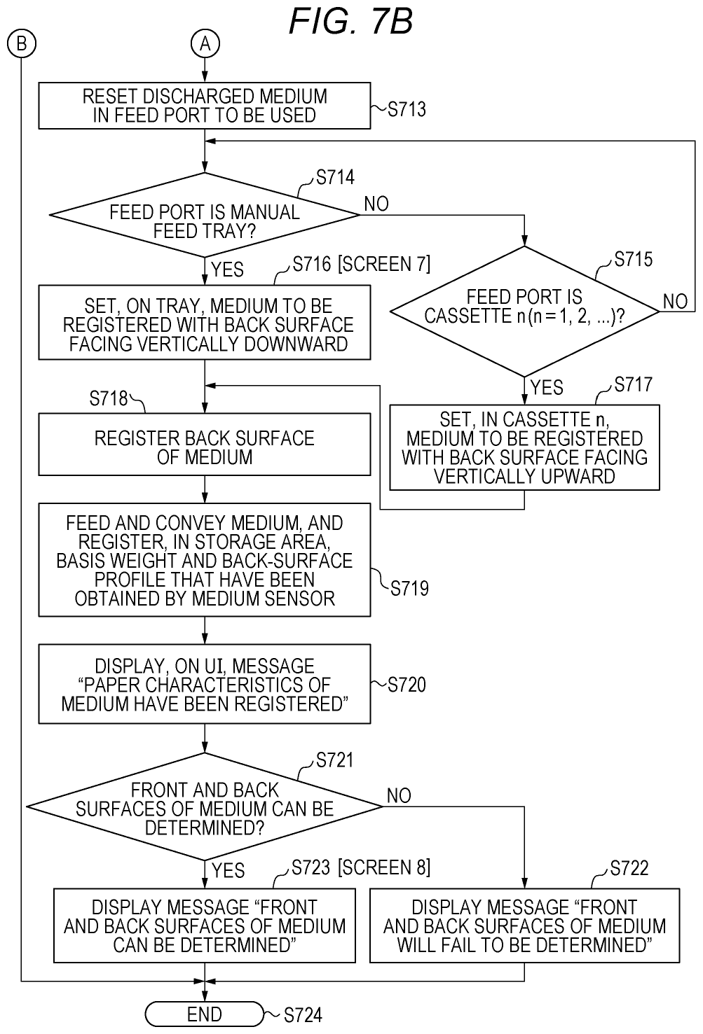

FIGS. 7A and 7B are diagrams illustrating a flow in a case where paper registration is performed in such a way that a medium (the recording medium P) is “wristband label A” in the first embodiment.

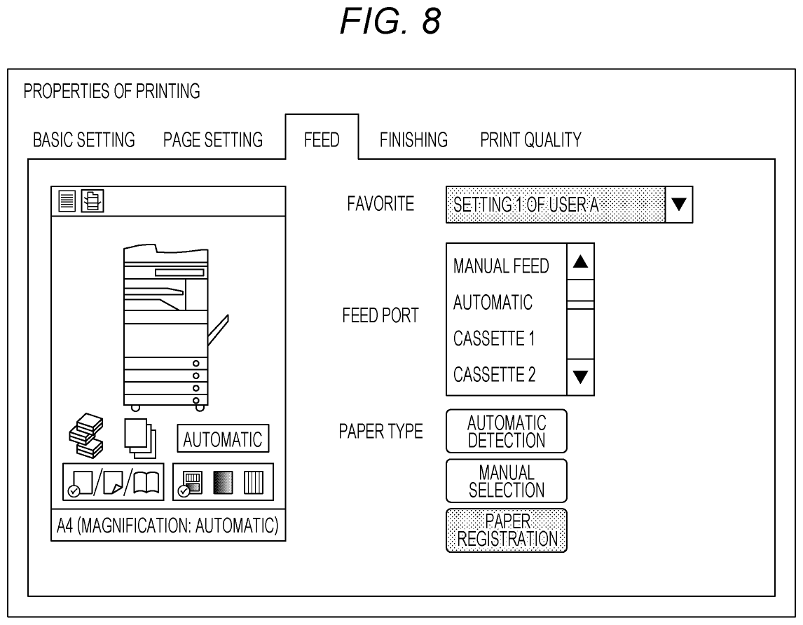

FIG. 8 is a diagram illustrating a screen (a registering unit) that is displayed on a display unit 71 or a printer driver screen when “paper registration” is performed on a feed setting menu of the image forming apparatus 100.

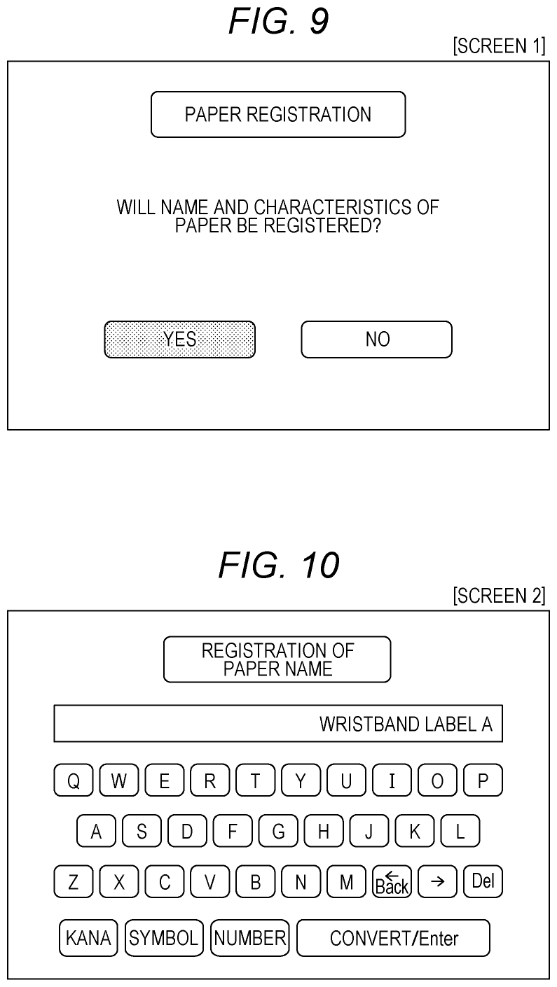

FIG. 9 is a diagram illustrating an introduction screen (referred to as [screen 1]) of “paper registration” that is displayed when paper registration has been selected on the feed setting menu.

FIG. 10 is a diagram illustrating a screen (referred to as [screen 2]) on which “paper name” is first registered in a paper registration flow according to the first embodiment.

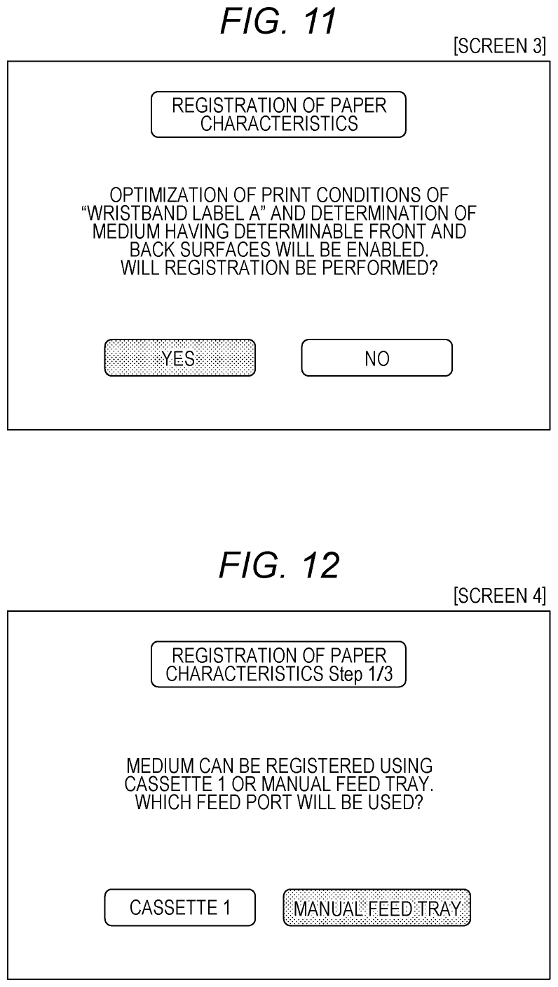

FIG. 11 is a diagram illustrating an introduction screen (referred to as [screen 3]) for registration of “paper characteristics” of a medium (a recording medium P) for which a name has been registered.

FIG. 12 is a diagram illustrating a screen (referred to as [screen 4]) on which a feed port to be used is selected when paper characteristics are detected and registered by using the medium sensors 12 and 13.

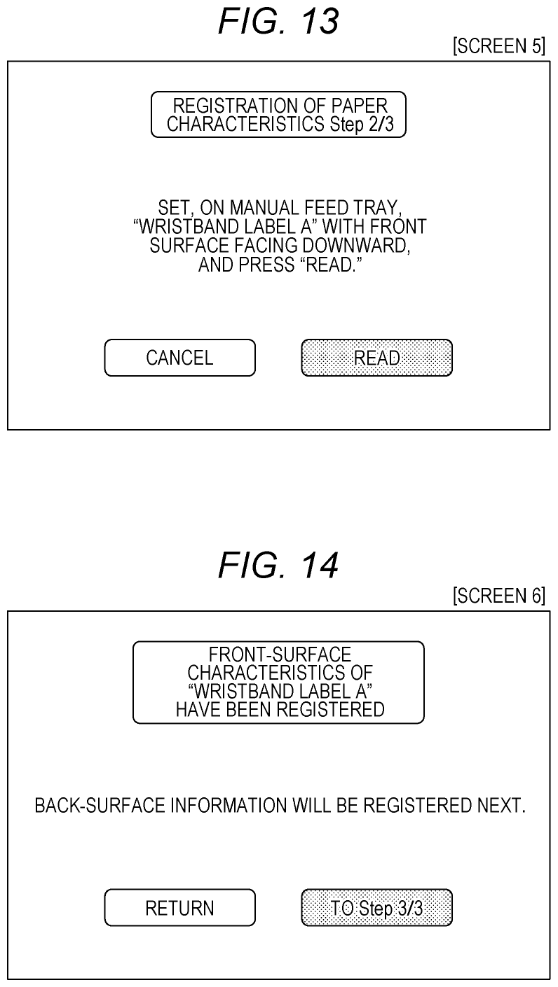

FIG. 13 is a diagram illustrating a screen (referred to as [screen 5]) on which information is provided relating to an orientation that corresponds to the selected feed port of a set surface of the medium (the recording medium P) and on which whether reading will be performed is selected.

FIG. 14 is a diagram illustrating a screen (referred to as [screen 6]) that indicates that information regarding a front surface of “wristband label A” has been registered and on which it is selected whether the processing will proceed to a next step or will return to a previous step.

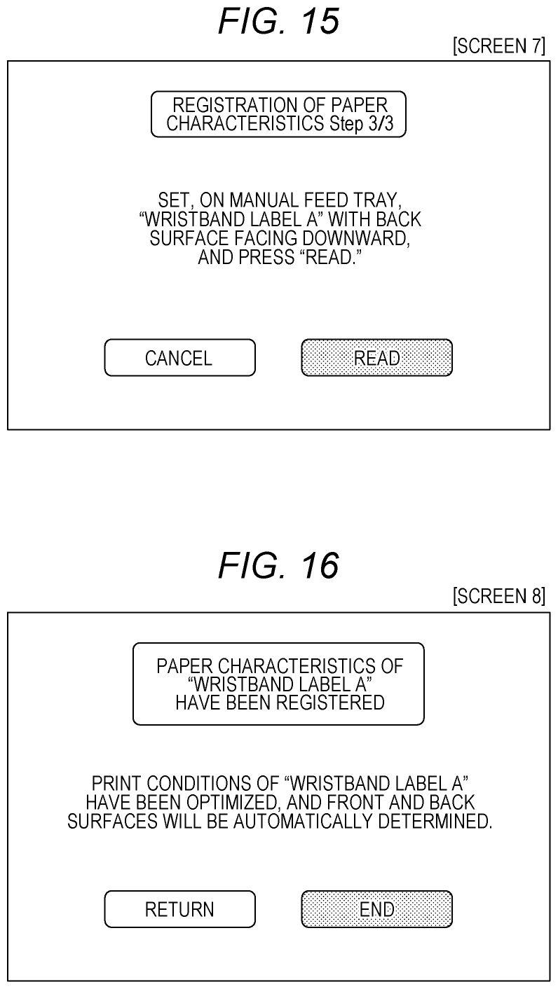

FIG. 15 is a diagram illustrating a screen (referred to as [screen 7]) on which information is provided relating to the registration of back-surface characteristics of “wristband label A” and an orientation of the set surface and on which whether reading will be performed is selected.

FIG. 16 is a diagram illustrating a screen (referred to as [screen 8]) that indicates that paper characteristics of “wristband label A” have been registered and that front and back surfaces can be automatically determined.

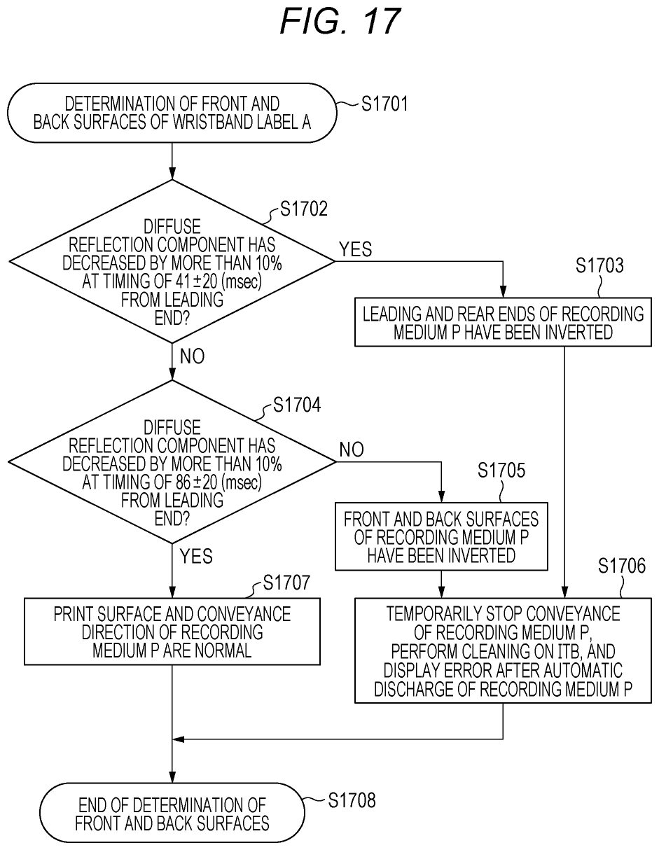

FIG. 17 is a diagram illustrating a flow of the determination of the front and back surfaces of “wristband label A.”

The image forming apparatus 100 according to the first embodiment registers, in a non-volatile storage area within the image forming apparatus 100, the name of a recording medium P (a sheet) having a distinction between front and back surfaces and surface characteristics of each of the front and back surfaces of the recording medium P.

The image forming apparatus 100 also determines whether the front and back surfaces can be determined. Details of the image forming apparatus 100 are described below.

First, an entire behavior of the image forming apparatus 100 is described with reference to FIG. 1.

The image forming apparatus 100 is a multifunction printer (MFP) that employs an electrophotographic method. An image data controller 90 converts image data that has been input from a print server 200 or the like into serial data having a form that is suitable for exposure scanning performed by a laser scanner unit 3.

In outputting an image, a CPU 80 (a controller) performs drive control on a main motor, a photosensitive drum motor, the laser scanner unit 3, or the like on the basis of various sensor signals or the like, in response to the image data from the image data controller 90. In outputting an image, the CPU 80 also performs various types of bias output control on electrostatically charge, development, transfer, or the like, performs energization control on a fixing heater, and performs other control on the basis of various sensor signals or the like, in response to the image data from the image data controller 90.

An interface 70 is an interface that is configured by a display unit 71, a key pad, an operation key 75, or the like. A display of a state of the image forming apparatus 100 and information and an input of a command from an operator are performed via the interface 70.

The image forming apparatus 100 includes four image forming stations (image forming units) that each form an image on a sheet that has been conveyed by a sheet conveying unit. The image forming unit includes a photoreceptor, a developing device, a charging device, and an exposing device that will be described later. The CPU 80 controls the image forming unit to perform the image formation process described later.

In photosensitive drums 1a, 1b, 1c, and 1d (photoreceptors), an organic photosensitive layer is formed on a surface layer of a conductor rotating member such as an aluminum cylinder. In the first embodiment, drive control is performed on the photosensitive drums 1a, 1b, 1c, and 1d at a peripheral speed of 220 mm/sec at the time of image formation, and a toner image is formed on a surface of each of the photosensitive drums 1a, 1b, 1c, and 1d in the image formation process.

In the first embodiment, a yellow toner image is formed on a surface of the photosensitive drum 1a, a magenta toner image is formed on a surface of the photosensitive drum 1b, a cyan toner image is formed on a surface of the photosensitive drum 1c, and a black toner image is formed on a surface of the photosensitive drum 1d.

Then, four toner images are primarily transferred onto an intermediate transfer belt (ITB) 6, the four toner images are further secondarily transferred onto a recording medium P (a sheet) via a secondary transfer roller 14, and the four toner images are output via a fixing unit 20.

A toner image formation process is described below by using, as an example, the formation of a yellow toner image, for simplification of description. When driving starts, bias application control is performed on a primary charging roller 2a (the charging device) via a control circuit, and the surface of the photosensitive drum 1a is uniformly and electrostatically charged. The laser scanner unit 3 (the exposing device) includes a semiconductor laser 30a, a laser driver, a polygon mirror 31, an f-θ lens 32a, and the like. Drive control is performed on the semiconductor laser 30a in accordance with image data that is equivalent to a yellow component, and an electrostatic latent image that corresponds to yellow is formed on the surface of the photosensitive drum 1a.

The electrostatic latent image is visualized as a yellow toner image by a developing unit 4a (the developing device). The yellow toner image is transferred via the primary transfer roller 5a onto the intermediate transfer belt 6 that is an intermediate transfer member. Similar to the yellow toner image, each of the magenta toner image, the cyan toner image, and the black toner image is superimposed onto the intermediate transfer belt 6. Then, control is performed to apply, to the secondary transfer roller 14, transfer bias according to the type of the recording medium P. The four tonner images on the intermediate transfer belt 6 are transferred onto a surface of the recording medium P, a fixing process is performed by the fixing unit 20 (the fixing device), and the four toner images are output onto a discharge tray 76.

In the first embodiment, the recording medium P (the sheet) is disposed on a sheet cassette 61, 63, 64, or 65 (a sheet storing unit) or a manual feed tray 62 (a sheet storing unit). In addition, the recording medium P (the sheet) is fed by a feed roller 9 (a sheet conveying unit) or a feed roller 19 (a sheet conveying unit) in synchronization with an image formation timing, and the recording medium P (the sheet) is conveyed at a speed of 220 mm/sec that is the same as the peripheral speed of the photosensitive drum 1. An image formation timing and an orientation of the fed recording medium P are corrected by a registration roller 10, and a leading end position and a rear end position of the fed recording medium P are detected by a top sensor 11.

In the first embodiment, medium sensors 12 and 13 (a first detecting sensor and a second detecting sensor) are disposed in a 20 mm downstream position of the top sensor 11 with a conveyance path of the recording medium P sandwiched between the medium sensors 12 and 13. Stated another way, the medium sensors 12 and 13 are disposed on a downstream side of the sheet storing unit and on an upstream side of the image forming unit with respect to a sheet conveyance direction of the sheet conveying unit. The medium sensors 12 and 13 are configured by the reference light irradiation photodiode 12-a1, the specular reflection light detection photodiode 12-a2, the diffuse reflection light detection photodiode 12-a3, the ultrasonic transmitter 12-b1, the ultrasonic receiver 13-b1, and the like.

In the first embodiment, as described later, after the recording medium P is fed, the irradiation of LED light and ultrasonic reference waves is started by the ultrasonic transmitter 12-b1. In synchronization with ON/OFF information of the top sensor 11, reflection waves and transmitted waves detected by the ultrasonic receiver 13-b1 in the medium sensors 12 and 13 are measured as a sampling waveform at the time of the absence of the recording medium P, a sampling waveform at the time of the presence of the recording medium P, and a sampling waveform with respect to time, and arithmetic processing is performed. Surface characteristics of the recording medium P to be conveyed (information regarding surface characteristics of the sheet) and a density and a basis weight of the recording medium P to be conveyed (information regarding a thickness of the sheet) are estimated according to an arithmetic result, and transfer and fixing conditions are optimized.

Transfer bias is applied to the secondary transfer roller 14 according to a result of determining the type of the recording medium P and the front and back surfaces of the recording medium P, and toner images are transferred onto the recording medium P. After the toner images have been transferred onto the recording medium P, the recording medium P passes through the fixing unit 20 that is configured by a heating unit 21, a pressing roller 22, and the like, and therefore the toner images are fixed. The recording medium P on which the toner images have been fixed is discharged onto the discharge tray 76.

FIG. 2 is a diagram illustrating a disposition relationship among the conveyance path of the recording medium P, the reference light irradiation photodiode 12-a1, the specular reflection light detection photodiode 12-a2, and the diffuse reflection light detection photodiode 12-a3. In the first embodiment, the reference light irradiation photodiode 12-a1, the specular reflection light detection photodiode 12-a2, and the diffuse reflection light detection photodiode 12-a3 are used to detect the surface characteristics of the conveyed recording medium P.

FIG. 3 is a diagram illustrating a disposition relationship among the conveyance path of the recording medium P, the ultrasonic transmitter 12-b1, and the ultrasonic receiver 13-b1. In the first embodiment, the ultrasonic transmitter 12-b1 and the ultrasonic receiver 13-b1 are used to specify a thickness (a density or a basis weight) of the conveyed recording medium P.

FIG. 4 is a diagram illustrating a print surface of a “medical wristband label” for which a paper name and surface characteristics of front and back surfaces are registered by a registering unit in the first embodiment and that serves as a target for the determination of the front and back surfaces. In the first embodiment, a size of the “medical wristband label” is a letter size having a longitudinal width of 279 mm and a lateral width of 216 mm.

In FIG. 4, F indicates a leading end in an orientation in which printing is performed with a wristband part facing forward in lateral feeding, and B indicates a rear end. Broken-line arrow F1-B1 illustrated as a forward direction indicates an orientation of conveyance with F as the head and a line along which the medium sensors 12 and 13 detect characteristics of a recording medium P. P1 indicates a position where a measurement line first intersects a boundary line of the label. Broken-line arrow B2-F2 illustrated as a backward direction indicates an orientation in the case of conveyance with B as the head and a line along which the medium sensors 12 and 13 detect characteristics of a recording medium P. P2 indicates a position where a measurement line first intersects a boundary line of the label.

FIG. 5A is a diagram illustrating an amount of diffuse reflection light on a front surface of the “medical wristband label” that is detected by the diffuse reflection light detection photodiode 12-a3 at the time of conveyance in the forward direction of the “medical wristband label.” A horizontal axis indicates a value in terms of a length in a conveyance direction, and the amount of diffuse reflection light has been standardized under the assumption that an average intensity during sheet supply is 100. In the first embodiment, an amount of diffuse reflection light is sampled at every 50 μsec, and a plot diagram of a moving average value of 10 consecutive pieces of data is formed.

In FIG. 5A, a part that has changed by more than 10% corresponds to a label boundary line (a step height) of a recording medium P. A position of P1 in FIG. 5A is 19 mm away from a detection position of a leading end of the recording medium P. If the position of P1 is converted into time, the position of P1 is equivalent to a point of 86.4 msec.

FIG. 5B is a diagram illustrating a profile of an amount of diffuse reflection light on the front surface of the “medical wristband label” that is detected by the diffuse reflection light detection photodiode 12-a3 at the time of conveyance of the “medical wristband label” in a backward direction with respect to the leading and rear ends, in a manner similar to the manner of FIG. 5A. A position of P2 in FIG. 5B is 9 mm away from a detection position of a leading end of the recording medium P. If the position of P2 is converted into time, the position of P2 is equivalent to a point of 41 msec.

FIG. 6 is a diagram illustrating a profile of an amount of diffuse reflection light on a back surface of the “medical wristband label” that is detected by the photodiode 12-a3 at the time of conveyance of the “medical wristband label” with the front and back surfaces inverted, in a manner similar to the manners of FIGS. 5A and 5B.

Here, a procedure of registering the paper name of the “medical wristband label” and characteristics of the front and back surfaces of the “medical wristband label” by using the registering unit according to the first embodiment is described with reference to the flowchart illustrated in FIGS. 7A and 7B. This processing is performed by the CPU 80 executing a control program that has been readout from a non-volatile storage area within the image forming apparatus 100 and has been developed in a RAM.

First, in registration of the name of paper and a front surface characteristics of the paper, “paper registration” is selected on a UT screen (FIG. 8) for feed setting of properties of printing on a printer driver displayed on the display unit 71 or a monitor connected to the print server 200 (S701 and S702).

Execution is selected on the UI screen (FIG. 9) for paper registration, and an arbitrary name is registered on the UI screen (FIG. 10) (S703 and S704). In the first embodiment, “wristband label A” is registered.

Feed from the sheet cassette 61, 63, 64, or 65 has a relationship between a set surface of a recording medium P and a transfer surface of tonner images that is reverse to the relationship in feed from the manual feed tray 62 (a multi-purpose tray). Therefore, in the registration of paper characteristics (FIG. 11), a feed port (the sheet storing unit) is selected on the UI screen (FIG. 12) (S705).

In the first embodiment, the manual feed tray 62 is selected as a feed port, and “wristband label A” is set with a print surface facing vertically downward (S706, S707, S708, and S709).

Execution of reading is selected on the UI screen (FIG. 13). By doing this, “wristband label A” is fed and conveyed, and the medium sensors 12 and 13 register a profile of an amount of reflected light as surface characteristics of the transfer surface of the toner images, and register a transmitted wave profile of ultrasonic waves as density characteristics (S710 and S711).

Arithmetic processing is performed on a light reflection wave profile of LED light and the transmitted wave profile of the ultrasonic waves, and therefore a message indicating that front-surface characteristics of “wristband label A” have been registered is displayed on the UI screen (FIG. 14) (S712).

Back-surface characteristics of “wristband label A” are registered according to the UT screen (FIG. 15) (S713, S714, S715, S716, and S717).

Arithmetic processing is performed on a light reflection wave profile and a transmitted wave profile of ultrasonic waves at the time of conveyance of the back surface of “wristband label A.” By doing this, a message indicating that back-surface characteristics have been registered and paper characteristics have been registered is displayed on the UI screen (FIG. 16) (S718, S719, and S720).

In the first embodiment, a correlation coefficient of a light reflection wave profile from a leading end to a rear end of a recording medium P is calculated between front and back surfaces, and if the correlation coefficient is less than 0.5, the front and back surfaces can be determined.

When a correlation coefficient is calculated for “wristband label A,” r=0.052 is established. Therefore, a message indicating that the front and back surfaces can be determined is displayed on the UI screen (FIG. 16), and medium registration is performed (S721, S723, and S724). In a case where the correlation coefficient is greater than or equal to 0.5, a message indicating that front and back surfaces of a corresponding medium will fail to be registered is displayed in the first embodiment (S722).

Next, a flow of the determination of front and back surfaces and leading and rear ends of “wristband label A” (S1701) is described with reference to the flowchart illustrated in FIG. 17. This processing is performed by the CPU 80 executing a control program that has been readout from the non-volatile storage area within the image forming apparatus 100 and has been developed in the RAM.

After the recording medium P has been fed, a leading end of the recording medium P is detected by the top sensor 11. In synchronization with this detection timing, the medium sensors 12 and 13 detect a diffuse reflection component. It is assumed that a point at which the diffuse reflection component has decreased by more than 10% (a label step height) is detected at a timing of 41±20 msec from a position of the detected leading end of the recording medium P. In this case, it is determined that the leading and rear ends of the recording medium P have been inverted (S1702 and S1703). At this time, conveyance of the recording medium P performed by the sheet conveying unit is temporarily stopped, and the CPU 80 controls the image forming unit to restrict the formation of an image on the recording medium P. In addition, toner images that have already been formed on the intermediate transfer belt 6 are cleaned, and the recording medium P is subsequently automatically discharged. Then, an error message (information indicating that the leading and rear ends of the recording medium P stored in the sheet storing unit have been inverted) is displayed on the display unit 71 (S1703, S1706, and S1708).

In contrast, it is assumed that it has not been detected at a timing of 41±20 msec from the position of the leading end of the recording medium P that the diffuse reflection component has decreased by more than 10% but it has been detected at a timing of 86±20 msec that the diffuse reflection component has decreased by more than 10%. In this case, it is determined that a print surface and a conveyance direction of “wristband label A” are normal (S1704, S1707, and S1708). At this time, the CPU 80 controls the image forming unit to permit the formation of an image on the recording medium P.

In a case where it is not detected at either a timing of 41±20 msec or a timing of 86±20 msec from the position of the leading end of the recording medium P that the diffuse reflection component has decreased by more than 10%/o, it is determined that the front and back surfaces of the recording medium P have been inverted (S1704 and S1705).

At this time, conveyance of the recording medium P performed by the sheet conveying unit is temporarily stopped, and the CPU 80 controls the image forming unit to restrict the formation of an image on the recording medium P. In addition, toner images that have already been formed on the intermediate transfer belt 6 are cleaned, and the recording medium P is subsequently automatically discharged. Then, an error message (information indicating that the front and back surfaces of the recording medium P stored in the sheet storing unit have been inverted) is displayed on the display unit 71 (S1705. S1706, and S1708).

A control example illustrated in FIG. 17 indicates an example in which both the front and back surfaces and the leading and rear ends of “wristband label A” conveyed by the sheet conveying unit are determined. However, this is not restrictive. A variation may be employed in which the front and back surfaces of “wristband label A” conveyed by the sheet conveying unit are determined but the leading and rear ends of “wristband label A” conveyed by the sheet conveying unit are not determined. Another variation may be employed in which the leading and rear ends of “wristband label A” conveyed by the sheet conveying unit are determined but the front and back surfaces of “wristband label A” conveyed by the sheet conveying unit are not determined.

Stated another way, in a first aspect according to the first embodiment, when “wristband label A” (a predetermined sheet having a distinction between front and back surfaces) is conveyed by the sheet conveying unit, a type and front and back surfaces of the predetermined sheet conveyed by the sheet conveying unit are determined.

Specifically, the type and the front and back surfaces of the predetermined sheet that has been conveyed are determined on the basis of information regarding surface characteristics of the predetermined sheet that have been detected by the medium sensors 12 and 13, and information regarding a thickness of the sheet and information regarding surface characteristics of the sheet that have been registered in advance in the registering unit. It is assumed that the determined type of the predetermined sheet matches the type of a sheet on which an image is to be formed by the image forming unit and the determined front and back surfaces of the predetermined sheet match front and back surfaces of the sheet on which the image is to be formed by the image forming unit. In this case, the image forming unit is controlled to permit the formation of the image on the predetermined sheet. In contrast, it is assumed that the determined type of the predetermined sheet matches the type of a sheet on which an image is to be formed by the image forming unit but the determined front and back surfaces of the predetermined sheet do not match front and back surfaces of the sheet on which the image is to be formed by the image forming unit. In this case, the display unit 71 is controlled to display, on the display unit 71, information indicating that the front and back surfaces of the predetermined sheet stored in the sheet storing unit have been inverted.

As described above, in the first aspect according to the first embodiment, a name and surface characteristics of a predetermined sheet having a distinction between front and back surfaces are individually registered, and arithmetic processing is performed. This enables the image forming apparatus 100 to automatically determine the front and back surfaces of the predetermined sheet having a distinction between the front and back surfaces. When an image is formed on the predetermined sheet having a distinction between the front and back surfaces, a type and the front and back surfaces of the sheet are determined. If the front and back surfaces of the sheet have been inverted, a report indicating that the front and back surfaces of the stored sheet have been inverted can be issued to a user. Therefore, in a case where a predetermined sheet having a distinction between front and back surfaces has been set with the front and back surfaces inverted, the first embodiment can suppress consumption of sheets or toner and the occurrence of downtime, that are conventionally caused, by noticing an error after an output and performing an output again.

In addition, in a second aspect according to the first embodiment, when “wristband label A” (a predetermined sheet having a distinction between leading and rear ends) is conveyed by the sheet conveying unit, a type and leading and rear ends of the predetermined sheet conveyed by the sheet conveying unit are determined. Specifically, the type and the leading and rear ends of the predetermined sheet that has been conveyed are determined on the basis of information regarding surface characteristics of the predetermined sheet that have been detected by the medium sensors 12 and 13, and information regarding a thickness of the sheet and information regarding surface characteristics of the sheet that have been registered in advance in the registering unit. It is assumed that the determined type of the predetermined sheet matches the type of a sheet on which an image is to be formed by the image forming unit and the determined leading and rear ends of the predetermined sheet match leading and rear ends of the sheet on which the image is to be formed by the image forming unit. In this case, the image forming unit is controlled to permit the formation of the image on the predetermined sheet. In contrast, it is assumed that the determined type of the predetermined sheet matches the type of a sheet on which an image is to be formed by the image forming unit but the determined leading and rear ends of the predetermined sheet do not match leading and rear ends of the sheet on which the image is to be formed by the image forming unit. In this case, the display unit 71 is controlled to display, on the display unit 71, information indicating that the leading and rear ends of the predetermined sheet stored in the sheet storing unit have been inverted.

As described above, in the second aspect according to the first embodiment, a name and surface characteristics of a predetermined sheet having a distinction between leading and rear ends are individually registered, and arithmetic processing is performed. This enables the image forming apparatus 100 to automatically determine the leading and rear ends of the predetermined sheet having a distinction between the leading and rear ends. When an image is formed on the predetermined sheet having a distinction between the leading and rear ends, a type and the leading and rear ends of the sheet are determined. If the leading and rear ends of the sheet have been inverted, a report indicating that the leading and rear ends of the stored sheet have been inverted can be issued to a user. Therefore, in a case where a predetermined sheet having a distinction between leading and rear ends has been set with the leading and rear ends inverted, the first embodiment can suppress consumption of sheets or toner and the occurrence of downtime, that are conventionally caused, by noticing an error after an output and performing an output again.

### Second Embodiment

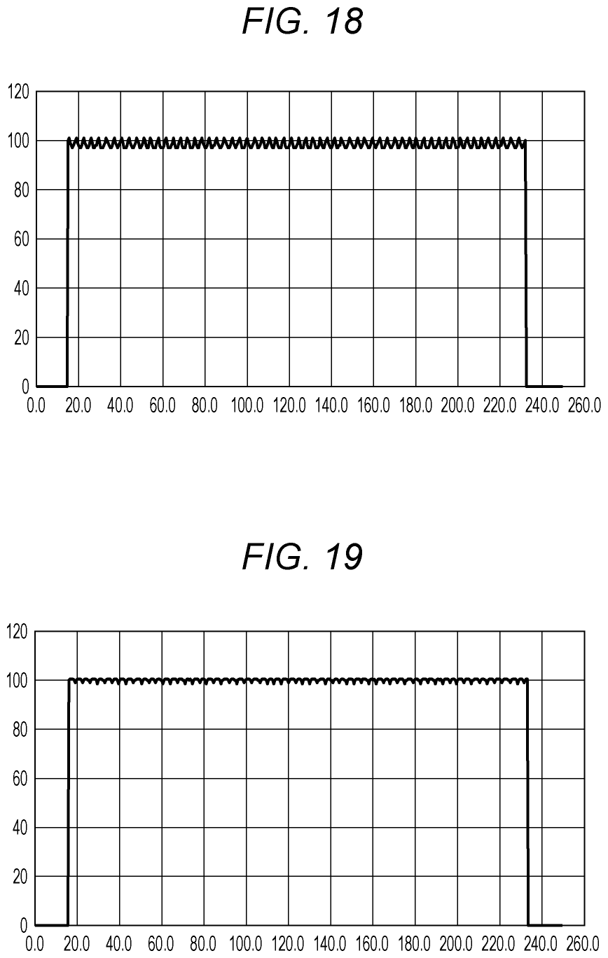

Next, a second embodiment of the present disclosure is described with reference to FIGS. 18 to 20.

In the second embodiment, embossed paper that has a periodical change in a diffuse reflection light component on a surface in contrast to label paper is used as an example. A correlation comparison of reflection waveforms is made between front and back surfaces, and determination is performed. Also in a recording medium P in which a significantly periodical change in a reflection waveform is not expected, such as bond paper or one-side coated paper, in a case where an amplitude of a waveform, a frequency component, or the like is significantly different between front and back surfaces, the front and back surfaces can be determined by calculating a correlation coefficient of waveforms of the front and back surfaces, or the like.

FIG. 18 illustrates a profile of diffuse reflection light that is detected by the medium sensors 12 and 13 in feeding and conveyance of a front surface of “emboss α” serving as a recording medium P. FIG. 19 illustrates a profile of diffuse reflection light that is detected by the medium sensors 12 and 13 in feeding and conveyance of a back surface of “emboss α.”

“Emboss α” in the second embodiment is an example of special embossed paper (a sheet having a unique emboss pattern). In “emboss α,” a pattern having a cycle of about 3.75 mm is formed on a front surface. Therefore, it is detected that a diffuse reflection light component on a front surface that is detected by the medium sensors 12 and 13 within the image forming apparatus 100 has a waveform having a fundamental frequency of about 59 Hz, as illustrated in FIG. 18.

Similarly with respect to a back surface, a waveform having a fundamental frequency of about 59 Hz is detected, but a diffuse reflection light profile is different. This is because the two waveforms have intensities different from each other of a higher-order frequency including a secondary frequency after Fourier transform.

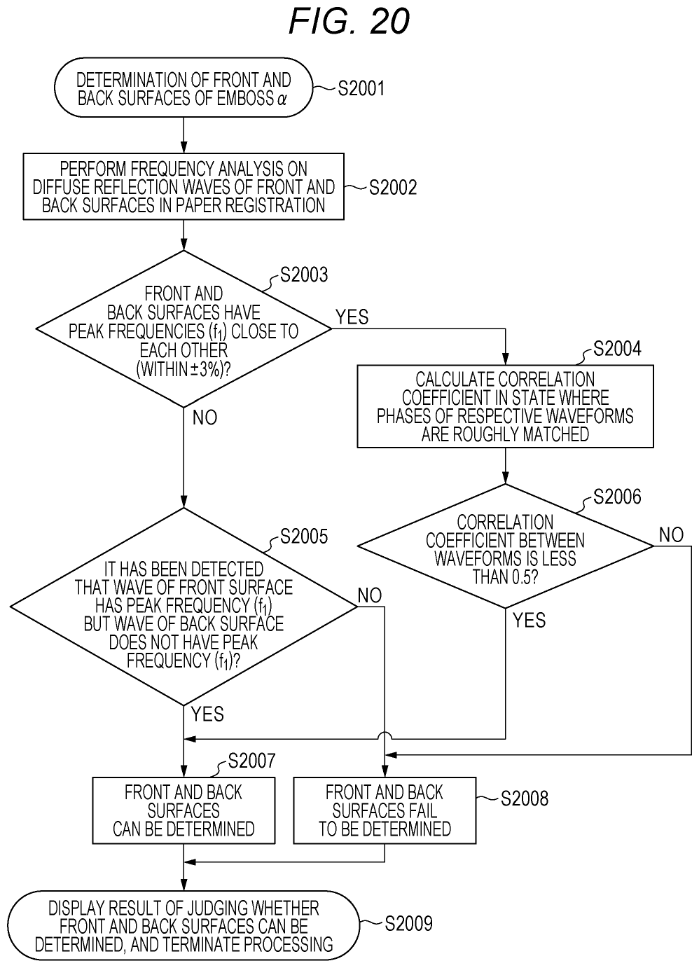

FIG. 20 is a diagram illustrating a flow of determining whether front and back surfaces of “emboss α” can be determined on the basis of diffuse reflection light data of the front surface and diffuse reflection light data of the back surface that have been detected in the paper registration of “emboss α” (S2001) according to the second embodiment. The flow of determining whether the front and back surfaces of “emboss α” can be determined is described with reference to FIG. 20. This processing is performed by the CPU 80 executing a control program that has been readout from a non-volatile storage area within the image forming apparatus 100 and has been developed in a RAM.

In the execution of paper registration, frequency analysis is performed on diffuse reflection light components of the front and back surfaces of emboss α that have been detected by the medium sensors 12 and 13 (S2001 and S2002).

It is detected whether fundamental frequencies of the front and back surfaces fall within frequency ranges (±3%) close to each other (S2003).

In a case where fundamental frequencies in waveforms of the front and back surfaces roughly overlap each other (±3%), phase matching is performed, and a correlation coefficient between the waveforms is calculated (S2004). In a case where the correlation coefficient between the waveforms is less than 0.5 (S2006: Yes), the CPU 80 determines that the front and back surfaces can be determined (S2007). In a case where the correlation coefficient between the waveforms is greater than or equal to 0.5 (S2006: No), the CPU 80 determines that the front and back surfaces will fail to be determined (S2008).

In a case where it is not detected that fundamental frequencies of diffuse reflection light components of front and back surfaces of a recording medium P fall within frequency ranges close to each other but it is detected that the diffuse reflection light component of the front surface of the recording medium P has a fundamental frequency, it is determined that the front and back surfaces can be determined (S2003, S2005, and S2007).

In a case where it is not detected that the fundamental frequencies of the diffuse reflection light components of the front and back surfaces of the recording medium P fall within frequency ranges close to each other and it is not detected that a waveform profile of the front surface of the recording medium P has a fundamental frequency, it is determined that the front and back surfaces will fail to be determined (S2003, S2005, and S2008).

In the paper registration of emboss α, a result indicating that the front and back surfaces can be determined or a result indicating that the front and back surfaces will fail to be determined is displayed on the display unit 71 or a monitor screen connected to the print server 200 or the like. By doing this, a result of determining whether the front and back surfaces can be determined is reported to an operator (S2009).

A correlation coefficient of an area from a leading end to a rear end of the recording medium P illustrated in FIGS. 18 and 19 is calculated as r=0.44. Therefore, in the second embodiment, it is determined that the front and back surfaces of “emboss α” can be determined.

As described above, frequency analysis is performed on diffuse reflection components of rays of light applied to front and back surfaces of a recording medium P, and arithmetic results of waveform data are analyzed. By doing this, in a case where whether the front and back surfaces of the recording medium P can be determined can be judged and in a case where the front and back surfaces of the recording medium P can be determined, consumption of sheets or toner or the occurrence of downtime due to erroneous printing on the back surface can be suppressed in the second embodiment.

### OTHER EMBODIMENTS

The present disclosure is not limited to the embodiments descried above. Various variations (including an organic combination of the individual embodiments) can be made on the basis of the spirit of the present disclosure, and the various variations should not be excluded from the scope of the present disclosure.

In the embodiments described above, description has been provided by using, as an example, the image forming apparatus 100 having a configuration in which the intermediate transfer belt 6 is used as an intermediate transfer member, as illustrated in FIG. 1. However, the present disclosure is not limited to this. The present disclosure can also be applied to an image forming apparatus having a configuration in which a recording medium P is sequentially brought into direct contact with photosensitive drums 1 and transfer is performed.

In the embodiments described above, description has been provided under the assumption that a developing unit 4 forms a single unit. However, similar effects can also be exhibited by employing a form of a process cartridge in which an image forming unit including the developing unit 4 has been integrally unitized and that is detachably attachable to the image forming apparatus 100. Further, the present disclosure can be applied to the image forming apparatus 100 including the developing unit 4 or the process cartridge described above regardless of whether it is a monochrome machine or a color machine.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-068891, filed Mar. 29, 2019, which is hereby incorporated by reference herein in its entirety.

What is claimed is:

1. An image forming apparatus for forming an image on a sheet, the image forming apparatus comprising:
a sheet storing unit configured to store the sheet;
a sheet conveying unit configured to convey the sheet stored in the sheet storing unit;
an image forming unit configured to form the image on the sheet conveyed by the sheet conveying unit;
a first detecting sensor configured to detect information regarding a thickness of the sheet conveyed by the sheet conveying unit, wherein the first detecting sensor is disposed on a downstream side of the sheet storing unit and on an upstream side of the image forming unit with respect to a sheet conveyance direction of the sheet conveying unit;
a second detecting sensor configured to detect information regarding a surface characteristics of the sheet conveyed by the sheet conveying unit, wherein the second detecting sensor is disposed on the downstream side of the sheet storing unit and on the upstream side of the image forming unit with respect to the sheet conveyance direction of the sheet conveying unit;
a registering unit configured to register the information regarding the thickness of the sheet detected by the first detecting sensor and the information regarding the surface characteristics of the sheet detected by the second detecting sensor;
a display unit; and
a controller configured to perform control, wherein, in a case where a predetermined sheet having a distinction between front and back surfaces has been conveyed by the sheet conveying unit, the controller performs control to:
determine, based on information regarding at least one sheet, the front and back surfaces of the predetermined sheet and a type of the predetermined sheet conveyed by the sheet conveying unit, wherein the information regarding the at least one sheet includes (i) information regarding a thickness of the predetermined sheet detected by the first detecting sensor, (ii) information regarding a surface characteristics of the predetermined sheet detected by the second detecting sensor, (iii) the registered information regarding the thickness of the sheet, and (iv) the registered information regarding the surface characteristics of the sheet,
control the image forming unit to permit formation of the image on the predetermined sheet, in a case where the determined type of the predetermined sheet matches a type of a sheet on which the image will be formed by the image forming unit and the determined front and back surfaces of the predetermined sheet matches front and back surfaces of the sheet on which the image will be formed by the image forming unit, and
control to display, on the display unit, information indicating that the front and back surfaces of the predetermined sheet stored in the sheet storing unit are inverted, in a case where the determined type of the predetermined sheet matches the type of the sheet on which the image will be formed by the image forming unit and the determined front and back surfaces of the predetermined sheet do not match the front and back surfaces of the sheet on which the image will be formed by the image forming unit.

2. The image forming apparatus according to claim 1, wherein, in a case where the predetermined sheet is conveyed by the sheet conveying unit, the controller further performs control to:
control the image forming unit to restrict the formation of the image on the predetermined sheet, in a case where the determined type of the predetermined sheet matches the type of the sheet on which the image will be formed by the image forming unit and the determined front and back surfaces of the predetermined sheet do not match the front and back surfaces of the sheet on which the image will be formed by the image forming unit.

3. The image forming apparatus according to claim 1, wherein the predetermined sheet includes a sheet having a unique label pattern.

4. The image forming apparatus according to claim 1, wherein the first detecting sensor includes a sensor configured to detect the information regarding the thickness of the sheet conveyed by the sheet conveying unit based on an intensity of transmitted waves and an intensity of reflection waves at a time when the sheet conveyed by the sheet conveying unit is irradiated with ultrasonic waves.

5. The image forming apparatus according to claim 1, wherein the second detecting sensor includes a sensor configured to detect the information regarding the surface characteristics of the sheet conveyed by the sheet conveying unit based on an amount of reference light and an amount of reflected light at a time when the sheet conveyed by the sheet conveying unit is irradiated with light.

6. An image forming apparatus for forming an image on a sheet, the image forming apparatus comprising:
a sheet storing unit configured to store the sheet;
a sheet conveying unit configured to convey the sheet stored in the sheet storing unit;
an image forming unit configured to form the image on the sheet conveyed by the sheet conveying unit;
a first detecting sensor configured to detect information regarding a thickness of the sheet conveyed by the sheet conveying unit, wherein the first detecting sensor is disposed on a downstream side of the sheet storing unit and on an upstream side of the image forming unit with respect to a sheet conveyance direction of the sheet conveying unit;
a second detecting sensor configured to detect information regarding a surface characteristics of the sheet conveyed by the sheet conveying unit, wherein the second detecting sensor is disposed on the downstream side of the sheet storing unit and on the upstream side of the image forming unit with respect to the sheet conveyance direction of the sheet conveying unit;
a registering unit configured to register the information regarding the thickness of the sheet detected by the first detecting sensor and the information regarding the surface characteristics of the sheet detected by the second detecting sensor;
a display unit; and
a controller configured to perform control, wherein, in a case where a predetermined sheet having a distinction between leading and rear ends has been conveyed by the sheet conveying unit, the controller performs control to:
determine, based on information regarding at least one sheet, the leading and rear ends of the predetermined sheet and a type of the predetermined sheet conveyed by the sheet conveying unit, wherein the information regarding the at least one sheet includes (i) information regarding a thickness of the predetermined sheet detected by the first detecting sensor, (ii) information regarding a surface characteristics of the predetermined sheet detected by the second detecting sensor, (iii) the registered information regarding the thickness of the sheet, and (iv) the registered information regarding the surface characteristics of the sheet,
control the image forming unit to permit formation of the image on the predetermined sheet, in a case where the determined type of the predetermined sheet matches a type of a sheet on which the image will be formed by the image forming unit and the determined leading and rear ends of the predetermined sheet matches leading and rear ends of the sheet on which the image will be formed by the image forming unit, and
control to display, on the display unit, information indicating that the leading and rear ends of the predetermined sheet stored in the sheet storing unit are inverted, in a case where the determined type of the predetermined sheet matches the type of the sheet on which the image will be formed by the image forming unit and the determined leading and rear ends of the predetermined sheet does not match the leading and rear ends of the sheet on which the image will be formed by the image forming unit.

7. The image forming apparatus according to claim 6, wherein, in a case where the predetermined sheet is conveyed by the sheet conveying unit, the controller further performs control to:
control the image forming unit to restrict the formation of the image on the predetermined sheet, in a case where the determined type of the predetermined sheet matches the type of the sheet on which the image will be formed by the image forming unit and the determined leading and rear ends of the predetermined sheet does not match the leading and rear ends of the sheet on which the image will be formed by the image forming unit.

8. The image forming apparatus according to claim 6, wherein the predetermined sheet includes a sheet having a unique label pattern.

9. The image forming apparatus according to claim 6, wherein the first detecting sensor includes a sensor configured to detect the information regarding the thickness of the sheet conveyed by the sheet conveying unit based on an intensity of transmitted waves and an intensity of reflection waves at a time when the sheet conveyed by the sheet conveying unit is irradiated with ultrasonic waves.

10. The image forming apparatus according to claim 6, wherein the second detecting sensor includes a sensor configured to detect the information regarding the surface characteristics of the sheet conveyed by the sheet conveying unit based on an amount of reference light and an amount of reflected light at a time when the sheet conveyed by the sheet conveying unit is irradiated with light.

11. A method for an image forming apparatus for forming an image on a sheet, wherein the image forming apparatus includes a first detecting sensor is disposed on a downstream side of a sheet storing unit and on an upstream side of an image forming unit with respect to a sheet conveyance direction of a sheet conveying unit, and a second detecting sensor is disposed on the downstream side of the sheet storing unit and on the upstream side of the image forming unit with respect to the sheet conveyance direction of the sheet conveying unit, the method comprising:
storing a sheet in the sheet storing unit:
conveying, via the sheet conveying unit, the sheet stored in the sheet storing unit;
forming, via an image forming unit, the image on the sheet conveyed by the sheet conveying unit;
detecting, via the first detecting sensor, information regarding a thickness of the sheet conveyed by the sheet conveying unit;
detecting, via the second detecting sensor, information regarding a surface characteristics of the sheet conveyed by the sheet conveying unit;
registering the information regarding the thickness of the sheet detected by the first detecting sensor and the information regarding the surface characteristics of the sheet detected by the second detecting sensor; and
performing control,
wherein, in a case where a predetermined sheet having a distinction between front and back surfaces has been conveyed by the sheet conveying unit, performing control includes performing control to:
determine, based on information regarding at least one sheet, the front and back surfaces of the predetermined sheet and a type of the predetermined sheet conveyed by the sheet conveying unit, wherein the information regarding the at least one sheet includes (i) information regarding a thickness of the predetermined sheet detected by the first detecting sensor, (ii) information regarding a surface characteristics of the predetermined sheet detected by the second detecting sensor, (iii) the registered information regarding the thickness of the sheet, and (iv) the registered information regarding the surface characteristics of the sheet,
control the image forming unit to permit formation of the image on the predetermined sheet, in a case where the determined type of the predetermined sheet matches a type of a sheet on which the image will be formed by the image forming unit and the determined front and back surfaces of the predetermined sheet matches front and back surfaces of the sheet on which the image will be formed by the image forming unit, and
control to display information indicating that the front and back surfaces of the predetermined sheet stored in the sheet storing unit are inverted, in a case where the determined type of the predetermined sheet matches the type of the sheet on which the image will be formed by the image forming unit and the determined front and back surfaces of the predetermined sheet do not match the front and back surfaces of the sheet on which the image will be formed by the image forming unit.

12. A non-transitory computer-readable storage medium storing a program to cause a computer to perform a method for an image forming apparatus for forming an image on a sheet, wherein the image forming apparatus includes a first detecting sensor is disposed on a downstream side of a sheet storing unit and on an upstream side of an image forming unit with respect to a sheet conveyance direction of a sheet conveying unit, and a second detecting sensor is disposed on the downstream side of the sheet storing unit and on the upstream side of the image forming unit with respect to the sheet conveyance direction of the sheet conveying unit, the method comprising:
storing a sheet in the sheet storing unit;
conveying, via the sheet conveying unit, the sheet stored in the sheet storing unit;
forming, via an image forming unit, the image on the sheet conveyed by the sheet conveying unit;
detecting, via the first detecting sensor, information regarding a thickness of the sheet conveyed by the sheet conveying unit;
detecting, via the second detecting sensor, information regarding a surface characteristics of the sheet conveyed by the sheet conveying unit;
registering the information regarding the thickness of the sheet detected by the first detecting sensor and the information regarding the surface characteristics of the sheet detected by the second detecting sensor; and
performing control,
wherein, in a case where a predetermined sheet having a distinction between front and back surfaces has been conveyed by the sheet conveying unit, performing control includes performing control to:
determine, based on information regarding at least one sheet, the front and back surfaces of the predetermined sheet and a type of the predetermined sheet conveyed by the sheet conveying unit, wherein the information regarding the at least one sheet includes (i) information regarding a thickness of the predetermined sheet detected by the first detecting sensor, (ii) information regarding a surface characteristics of the predetermined sheet detected by the second detecting sensor, (iii) the registered information regarding the thickness of the sheet, and (iv) the registered information regarding the surface characteristics of the sheet,
control the image forming unit to permit formation of the image on the predetermined sheet, in a case where the determined type of the predetermined sheet matches a type of a sheet on which the image will be formed by the image forming unit and the determined front and back surfaces of the predetermined sheet matches front and back surfaces of the sheet on which the image will be formed by the image forming unit, and
control to display information indicating that the front and back surfaces of the predetermined sheet stored in the sheet storing unit are inverted, in a case where the determined type of the predetermined sheet matches the type of the sheet on which the image will be formed by the image forming unit and the determined front and back surfaces of the predetermined sheet do not match the front and back surfaces of the sheet on which the image will be formed by the image forming unit.
